(19) United States
(12) Patent Application Publication
(10) Pub. No.: US 2019/0040234 A1
(43) Pub. Date: Feb. 7, 2019

(54) POLYMER COMPOSITION COMPRISING A FIRE SUPPRESSANT

(71) Applicant: DEFLAMO AB, Karlshamn (SE)

(72) Inventor: Fredrik WESTIN, Stockholm (SE)

(21) Appl. No.: 16/074,955

(22) PCT Filed: Feb. 2, 2017
(86) PCT No.: PCT/SE2017/000007

§ 371 Date: Aug. 2, 2018

(30) Foreign Application Priority Data
Feb. 3, 2016 (SE) 1630019-6

(51) Int. Cl. C08K 13/02; C08F 14/00; C08K 5/092; C08K 5/098; C08K 3/32; C08K 3/22; C08K 3/26; C09K 21/04; C09K 21/06

(52) U.S. Cl. CPC C08K 13/02; C08K 2003/2224; C08K 5/092; C08K 5/098; C08K 3/32; C08K 3/22; C08K 3/26; C09K 21/04; C09K 21/06; C08K 2003/329; C08K 2003/321; C08K 2003/262; C08K 2003/265; C08K 2003/267; C08K 2003/2206; C08F 14/00

(57) ABSTRACT

The present invention refers to a polymer composition comprising a polymer and a fire suppressant in form of a mixed salt based on a) at least one mono-, di- and/or tri-carboxylic acid, b) at least one polyphosphoric, pyrophosphoric and/or phosphoric acid, c) a hydroxide or a salt of an alkali or an alkaline earth metal, where a) and c) form a carboxylate and b) and c) form a phosphate and optionally d) a carbonate of an alkali or an alkaline earth metal. The mixed salt have an average particle size in the range of 0.2 to 50 μm and a crystalline water content of at least 5% by weight. The mixed salt is present in an amount of 5-70% by weight of the total composition. The polymer composition might further comprise one or more additives.

The present invention refers to a polymer composition, comprising a polymer and a fire suppressant in form of a mixed salt based on at least one carboxylate and at least one phosphate, a hydroxide or a salt of an alkali or an alkaline earth metal and optionally a carbonate and one or more additives.

There is a major demand for fire suppressants in the global plastic industry since polymer resins typically have very harmful burning characteristics. They have a high flammability at relative low temperatures and when exposed to fire, the polymeric material starts to drip, which serves to spread the fire, emitting large quantities of smoke and toxic gases.

It is well known in the art that the flammability of polymer resins can be reduced by incorporating fire suppressants. There are many additives with fire suppressing properties available on the market, but unfortunately many of them release very toxic gases. Halogenated fire suppressants for instance have an excellent performance but many of these chemicals are associated with health and environmental problems. As a result, several brominated and chlorinated fire suppressants have been forbidden and several more are questioned in the environmentally aware community.

Some polymers are inherently fire suppressant because they contain elements, such as halogen, large quantities of nitrogen and the like, which render them fire suppressant. Examples of inherently fire suppressant polymers are polyvinyl chloride, polytetrafluoroethylene, chlorinated polyethylene, aromatic polyamides, polyesters of halogenated anhydrides and high molecular weight halogenated aromatic polycarbonates.

Polyvinyl chloride (PVC) is widely used as a component in flexible substrate compositions. In unmodified form, PVC has relatively good fire suppressant properties due to its high chloride content. When PVC is burning, hydrogen chloride gas resulting from thermal cracking slows down the continuous combustion reaction and prevents burning progress. Since PVC by itself is a rigid, inflexible thermoplastic, flexible substrate compositions based on PVC are formulated with relatively large amounts of plasticizers to improve the flexibility of the end product. The presence of these plasticizers increases the flammability of the final coating.

For this reason, various fire suppressing and smoke suppressing ingredients are sometimes needed in flexible substrate compositions based on PVC. It is however, difficult to simultaneously achieve both sufficient fire and smoke suppression with maintained physical and mechanical properties of the polymer composition. Compounds that suppress fire typically cause incomplete combustion, thereby increasing the amount of smoke generated, while smoke suppressants can function by creating higher heats of combustion to more efficiently consume combustible organic gases. Antimony trioxide or aluminium trihydroxide (ATH) for example, can be effective fire suppressants, but increase the amount of smoke generated in a fire. It would therefore be advantageous to find alternatives that suppress fire without contributing to smoke generation.

Finding a suitable fire suppressant for a certain polymer composition is rather complex, the problem with combining substances is that the result is not always given. There are PVC resins which are formulated with phosphate ester plasticizers in order to pass various fire suppression tests, because phosphate esters have superior fire suppressant characteristics compared to other types of plasticizers. The antagonism between antimony and phosphorus is well known and documented in the literature, but thus far using both such types of substances in combination has been the only way known to achieve certain desired levels of fire suppression. It would be advantageous and beneficial to find fire suppressants that work effectively in the presence of phosphate ester plasticizers. Sufficient fire suppression would then be reached with a lower amount of fire suppressant.

Many prior art references describe the use of different fire suppressants, such as reactive or additive halogenated organic compounds, inorganic fillers, solvents, and special formulations based on phosphorous and ammonium salts. There are for instance mineral fire suppressants that are non-toxic (e.g. aluminium trihydroxide and magnesium dihydroxide) and work by decomposing endothermically. This means that at a certain temperature, the compounds disintegrate thereby adsorbing heat and releasing water vapor. The oxides that are formed results in a protective layer that provides a smoke suppressing and oxygen depriving effect.

Despite the obvious advantages of mineral fire suppressants, it is not always possible to replace halogenated fire suppressants. To reach flammability standards in demanding applications, mineral fire suppressants need to be added in very high dosage levels (up to 80% by weight). Such high levels of additives will radically deteriorate the physical properties of the polymer.

The interaction between the polymer resin and the fire suppressant is rather complex. The fire suppressant property of an additive in a polymer formulation varies very much with the nature of the substrate, especially for intumescent compositions, where the rapid formation of a protective char is highly dependent on combustion temperature and viscosity of the melt formed by the burning substrate.

The object of the invention is to provide a polymer composition comprising a fire suppressant that supresses both fire and smoke and overcomes the mentioned problems with prior art. Another object of the invention is to provide a polymer composition comprising a fire suppressant where the mechanical properties of the polymer are maintained. A further object of the invention is to provide a fire suppressant that also makes the incorporation into any suitable polymer resin and the subsequent compounding of the polymer resin very efficiently. Another object of the invention is to provide a way to assure an even and sufficient fire suppressive effect in all of the polymer resin.

The present invention accordingly refers to a polymer composition comprising a polymer and a fire suppressant in form of a mixed salt based on
a) at least one mono-, di- and/or tri-carboxylic acid,
b) at least one polyphosphoric, pyrophosphoric and/or phosphoric acid,
c) a hydroxide or a salt of an alkali or an alkaline earth metal,
   where a) and c) form a carboxylate and b) and c) form a phosphate and optionally
d) a carbonate of an alkali or an alkaline earth metal.

The mixed salt have an average particle size in the range of 0.2 to 50 μm and a crystalline water content of at least 5% by weight. The mixed salt is present in an amount of 5-70% by weight of the total composition. The polymer composition might further comprise one or more additives.

The amount of mixed salt present in the polymer composition of the invention depends mainly on the fire suppressing demands of the final polymer composition, the shape of the final polymer article and on the amount of plasticiser present in the polymer composition. If for example the final article has thicker gods, i.e. low specific area per volume and no high demands on fire suppressing properties, the amount of mixed salt is lower compared to cases where the article has higher specific area per volume, the fire suppressing demands are higher or the amount of plasticiser is higher.

The polymer in the composition of the invention is preferably a thermoplastic polymer. In a preferred embodiment of the invention the polymer is a plasticised polyvinyl halide and the amount of plasticiser is preferably 10-50% by weight depending on the demands on the final polymer composition. The polyvinyl halide is preferably selected from the group consisting of polyvinylfluoride (PVF), polyvinyl chloride (PVC), chlorinated polyvinyl chloride (CPVC), polyvinylidene fluoride (PVDF) or polytetrafluoroethylene (PTFE) and most preferably PVC.

The polymer in the composition of the invention could also be a thermoplastic polyolefin, such as polyethylene (PE), polypropylene (PP), polymethylpentene (PMP) or polybutene-1 (PB-1); a polyolefin elastomer, such as polyisobutylene (PIB), ethylene propylene rubber (EPR) or ethylene propylene diene monomer rubber (EPDM rubber) or polystyrene (PS). The polymer in the composition of the invention could further be a thermoplastic elastomer (TPE), like thermoplastic polyurethane (TPU) or expanded thermoplastic polyurethanes (E-TPU).

The carboxylate of the present invention is based on at least one C₂-C₆ mono-, di- and/or tri-carboxylic acid, preferably at least one C₂-C₆ di-carboxylic acid and most preferably at least two C₂-C₆ di-carboxylic acids. In a preferred embodiment of the invention the carboxylate is based on at least one mono-, di- and/or tri-carboxylic acid selected from the group consisting of ethanoic acid, ethanedioic acid, oxoethanoic acid, 2-hydroxyethanoic acid, propanoic acid, prop-2-enoic acid, propanedioic acid, 2-oxopropanoic acid, 2-hydroxypropanoic acid, butanoic acid, 2-methylpropanoic acid, butanedioic acid, 3-oxobutanoic acid, butenedioic acid, oxobutanedioic acid, hydroxybutanedioic acid, 2,3-dihydroxybutanedioic acid, but-2-enoic acid, pentanoic acid, pentanedioic acid, 2-oxopentanedioic acid, hexanoic acid, hexanedioic acid, 2-hydroxypropane-1,2,3-tricarboxylic acid, prop-1-ene-1,2,3-tricarboxylic acid, 1-hydroxypropane-1,2,3-tricarboxylic acid, propane-1,2,3-tribarboxylic acid and hexa-2,4-dienoic acid. Preferably a) is at least one ethanoic acid, ethanedioic acid, 2,3-dihydroxybutanedioic acid and/or 2-hydroxypropane-1,2,3-tricarboxylic acid and most preferably a) is an ethanedioic acid (also known as oxalic acid) and a 2,3-dihydroxybutanedioic acid (also known as tartaric acid). The preferred carboxylic acids of a) are classified as strong acids.

The mixed salt of the invention is based on more than 50% carboxylates. Another way of expressing the proportions of the different salts in the mixed salt of the invention is that the mixed salt is based on less than 30% phosphates. The presence of both carboxylate and phosphate is of essence for the significant fire and smoke suppressing property of the composition of the invention. This special mix of carboxylates and phosphates makes the salt more reactive to initial combustion products and these reactions form more desirable products with less flammable and toxic properties. A great advantage with the polymer composition of the present invention is the intumescent feature of the mixed salt, i.e. its ability to form a protective char layer instead of toxic gases when exposed to heat.

The alkali or alkaline earth metal of c) and d) of the mixed salt of the invention is selected from the group consisting of sodium, potassium, calcium and magnesium. In a preferred embodiment of the invention the cation of the carboxylate and the phosphate is calcium, i.e. c) is calcium hydroxide and the optional d) is calcium carbonate. The mixed salt of the invention is preferably formed by acid-base reactions and natural crystallisation. An alternative method to form the mixed salt of the invention is by ion exchange. The carboxylate and phosphate are then formed by ion exchange between a) and c), and b) and c), respectively, where c) suitably is an alkali or alkaline earth metal salt of a carboxylic acid weaker than the carboxylic acid(s) of a). When forming the mixed salt of the invention by ion exchange, c) is suitably calcium acetate or calcium citrate.

When the alkali or alkaline earth metal carbonate d) of the mixed salt is present in the polymer composition it acts as a smoke suppressant. Said carbonate is preferably calcium carbonate and is suitably present in an amount of at least 3% by weight of the mixed salt. A major advantage with the polymer composition of the invention is its ability to suppress both fire and smoke. The polymer composition of the invention suppresses fire in multiple different fashions. The different ingredients are activated at different temperatures and both fire and smoke are suppressed.

The pH of the mixed salt of the invention is preferably in the range of 8-13.

A great advantage with the polymer composition of the present invention is the small average particle size of the mixed salt. In a preferred embodiment of the present invention the average particle size of the mixed salt is in the range of 0.5 to 20 μm and even more preferably in the range of 1 to 5 μm. The particle size and shape of the salt crystals will influence the functionality in the final application. Smaller particles will provide a better fire suppressing property per weight and lower impact on the physical and mechanical properties of the polymer resin. It will also improve the processability when injection molding, blow molding and film blowing polymer resins in accordance with the present invention as compared to prior art technology. Fire suppressants in form of salts are typically grinded into a powder and then incorporated into the polymer resin. The grinding process creates crystals with sharp edges that may cause trouble in the molding process of the polymer resin. An advantage with the polymer composition of the present invention is that the powder of the fire suppressant has not been grinded, i.e. the crystals of the mixed salt are natural grown with even shapes and no sharp edges. These small, natural grown crystals of the fire suppressant make the incorporation into the polymer resin and the subsequent compounding of the polymer resin go very efficiently.

Another huge advantage with the fire suppressant of the invention is the uniform distribution of the different components of the mixed salt. In each salt crystal the different components are represented. If the incorporation of the mixed salt into the polymer resin is successful i.e. the mixed salt is evenly distributed in the polymer resin, you can be sure that the effect of the fire suppressant will be the same in all of the polymer resin. A mixed salt that has been formed by mixing different salts together will not exhibit the same advantage of even distribution because the different salts in the mixed salt will have different crystal shapes and during storage and handling will end up unevenly distributed due to physical effects. With a mixed salt where the components are unevenly distributed, it does not matter whether the incorporation of the mixed salt into the polymer resin is successful, the active components of the mixed salt will be unevenly distributed and consequently decrease the efficiency of the fire suppressant. The composition according to the present invention will accordingly provide a better fire suppression per unit of incorporated salts than that of prior art technology. The mixed salt of the present invention is incorporated into the polymer by conventional polymer compounding techniques.

The polymer composition of the invention can advantageously be used in transparent thermoplastic applications with greatly improved optical properties as compared to prior art technology. For instance in a variety of polycarbonate applications were the presence of a fire suppressant could be useful. An interesting application area for the composition of the present invention could be in soft-vinyl enclosure windows in applications for marine, restaurant decks and patios, expositions, trade shows, and party tents. The polymer composition of the invention can of course also successfully be used in opaque thermoplastic applications.

The polymer composition of the invention may also comprise one or more additives selected from the group consisting of heat and UV stabilizers, smoke suppressants, plasticizers, reinforcing additives, processing aids, impact modifiers, thermal modifiers, pigments and fillers. The additives are added in conventional amounts for their conventionally employed purposes.

1. A polymer composition comprising a polymer and a fire suppressant in form of a mixed salt based on
a) at least one mono-, di- and/or tri-carboxylic acid,
b) at least one polyphosphoric, pyrophosphoric and/or phosphoric acid,
c) a hydroxide or a salt of an alkali or an alkaline earth metal,
where a) and c) form a carboxylate and b) and c) form a phosphate, and
d) optionally, a carbonate of an alkali or an alkaline earth metal,
the mixed salt having an average particle size in the range of 0.2 to 50 μm and a crystalline water content of at least 5% by weight,
the mixed salt being present in an amount of 5 to 70% by weight of the total composition and
the composition optionally comprises one or more additives.

2. The composition according to claim 1, wherein the polymer is thermoplastic.

3. The composition according to claim 1, wherein the polymer is a plasticised polyvinyl halide.

4. The composition according to claim 1, wherein the polymer is a polyvinyl halide comprising plasticiser in an amount of 10 to 50% by weight.

5. The composition according to claim 1, wherein a) is at least one C₂-C₆ mono-, di- and/or tri-carboxylic acid.

6. The composition according to claim 1, wherein a) is at least one C₂-C₆ di-carboxylic acid.

7. The composition according to claim 1, wherein a) is at least two C₂-C₆ di-carboxylic acids.

8. The composition according to claim 1, wherein a) is at least one of ethanoic acid, ethanedioic acid, 2,3-dihydroxybutanedioic acid and 2-hydroxypropane-1,2,3-tricarboxylic acid.

9. The composition according to claim 1, wherein the mixed salt is based on more than 50% carboxylates.

10. The composition according to claim 1, wherein the mixed salt is based on less than 30% phosphates.

11. The composition according to claim 1, wherein the alkali or alkaline earth metal of c) and d) is selected from the group consisting of sodium, potassium, calcium and magnesium.

12. The composition according to claim 1, wherein c) is a salt and the carboxylate and phosphate are formed by ion exchange.

13. The composition according to claim 12, wherein c) is a salt of a weaker carboxylic acid than the carboxylic acid(s) of a).

14. The composition according to claim 1, wherein the carbonate d) is present in an amount of at least 3% by weight of the mixed salt.

15. The composition according to claim 1, wherein the average particle size of the mixed salt is in the range of 0.5 to 20 μm.

16. The composition according to claim 1, wherein the average particle size of the mixed salt is in the range of 1 to 5 μm.

17. The composition according to claim 1, wherein a pH of the mixed salt is in the range of 8 to 13.

18. The composition according to claim 1, wherein the mixed salt has a natural grown crystal structure.

19. The composition according to claim 1, wherein the composition is used in transparent thermoplastic applications.

20. The composition according to claim 1, wherein the optional additives are selected from the group consisting of heat and UV stabilizers, smoke suppressants, plasticizers, reinforcing additives, processing aids, impact modifiers, thermal modifiers, pigments and fillers.
